(19) United States
(12) Patent Application Publication
(10) Pub. No.: US 2007/0150574 A1
(43) Pub. Date: Jun. 28, 2007

(54) Method for detecting, monitoring, and controlling web services

(76) Inventors: Rizwan Mallal, Newton, MA (US); Mamoon Yunus, Newton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/634,518

(22) Filed: Dec. 6, 2006

Related U.S. Application Data
(60) Provisional application No. 60/742,722, filed on Dec. 6, 2005.

(51) Int. Cl. G06F 15/173

(52) U.S. Cl. 709/223

(57) ABSTRACT

A method scans SOAP and/or XML messages over TCP/IP and performs detection, monitoring, validation, and/or prevention from a monitoring, compliance, security, or integrity perspective. The method achieves these goals through a combination of scanning SOAP and/or XML non-intrusively, without reliance on Web Service Definition Language (WSDL), and providing external enforcement. The combination of non-intrusiveness, WSDL-blindness, and external enforcement techniques truly provides a scalable and reliable deployment of Web Services at the enterprise level.

### RELATED APPLICATION

This application claims the benefit of U.S. Provisional Application No. 60/742,722, filed on Dec. 6, 2005. The entire teachings of the above application are incorporated herein by reference.

### BACKGROUND OF THE INVENTION

This invention relates generally to SOAP/XML intrusion detection, monitoring, and prevention. More specifically, the invention relates to a system and method for detecting and preventing unauthorized or malicious SOAP/XML messages from traversing internal and external networks by generating filters based on static and/or dynamic signatures.

Computer networks allow electronic machines and computers to communicate. The communication is achieved using network protocols that define a set of rules for passing data between machines. The network protocols follow the standard Open Systems Interconnect (OSI) network protocol model as illustrated in FIG. 1. The OSI model divides network responsibilities into seven discrete layers, namely the physical layer, the data link layer, the network layer, the transport layer, the session layer, the presentation layer, and the application layer. Each layer is responsible for performing specific tasks, and performs these tasks effectively independent from the other layers.

One of the most commonly used computer network protocols is the Transmission Control Protocol/Internet Protocol (TCP/IP). TCP/IP's structure maps to the transport and network layers of the OSI model. TCP/IP typically sits on top of a device driver, which is the software responsible for managing the hardware underneath it. The hardware can encompass a network card or a network interface such as an Ethernet device.

The Internet Protocol (IP) layer is responsible for delivering data from one machine to the appropriate destination machine. It acts as a network traffic manager ensuring data sent out on a computer network reaches its appropriate destination. Without the IP layer, data on a computer network would not be able to reach its appropriate destination. The IP layer directs data from one computer to another, or one device to another, based on unique IP addresses.

Above the Internet Protocol (IP) layer in the TCP/IP network stack is the Transmission Control Protocol (TCP) layer, which is equivalent to the transport layer of the OSI model. TCP is responsible for ensuring that the data is delivered reliably. It ensures that the data is not corrupted or duplicated during transmission. TCP achieves this reliability through acknowledgements, timeouts, and retransmissions. TCP divides the data provided from higher level layers into chunks of information, also referred to as packets or TCP segments, which are then passed to the IP layer below it. It also takes incoming packets from the IP layer and combines them into data that can be used by the upper layers. Within the TCP layer, data is treated as a stream of bytes traveling over a TCP socket, or connection, which is specified by the source IP address, port on the source device, destination IP address, and port on the destination device.

The TCP/IP stack generally combines the responsibilities of the OSI session and presentation layers into a single layer, which is implemented through a variety of protocols including, but not limited to, Telnet, File Transfer Protocol (FTP), Hypertext Transfer Protocol (HTTP), Secure HTTP (HTTPS), and Simple Mail Transport Protocol (SMTP). Each of these protocols typically listens for data on, and receives data from, one or more specific TCP ports. These protocols take information from user-level applications and formats it for transmission across a network. For example, the SMTP protocol adds date and time headers; To, From, and Reply to address information, and the like to an E-mail message before it is sent, so that a receiving E-mail server can properly process and display the information.

As applications listen for data on TCP ports over the internet, they are subject to an attack by malicious users. Any user who has access to a desktop running the TCP/IP protocol stack can connect to an application on a remote host over the internet and try to extract data. Applications without a layer of security may be subject to disruption or loss of data. Initially, a layer of security was provided by a firewall, which has been around for quite some time and was originally used to define a barrier constructed to prevent untrusted users from accessing hosts. A firewall's security design logic is enforced using the same type of packet-screening method. Each method uses information from different layers of the OSI stack model. These methods are based on how firewalls use pre-configured rules or filters to allow or deny traffic from specific hosts or users.

Firewalls have their own shortcomings where they only allow or deny traffic based on a set of rules or filters. Firewalls do not look for specific patterns in a traffic for suspicious activity. Even though, a firewall allows traffic to be passed to a remote host, the traffic might still contain suspicious data patterns that may allow a user to subvert an application. Intrusion Detection Systems (IDS) were introduced to monitor network traffic and specifically look for suspicious activity. If suspicious activity is detected in a network traffic, an alert is thrown by the system. IDS comes in a variety of flavors. There are network based and host based intrusion detection systems. Network Intrusion Detection Systems (NIDS) are placed at a strategic point or points within the network to monitor traffic passively to and from all devices on the network.

Host Intrusion Detection Systems (HIDS) run on individual hosts on the network. A HIDS monitors the inbound and outbound packets from the host only. IDSs that can go beyond throwing alerts and actually block suspicious traffic are known as Intrusion Prevention Systems (IPS). IPSs can also be classified as host based or network based.

The pattern that an IDS or IPS uses to detect suspicious activity is based on signatures. A signature is written to detect odd traffic patterns on the network. A signature could be written, for example, to detect unusual TCP/IP header characteristics. Some signatures can be based on a specific attack on a well known platform. There are multiple uses of signatures in an IDS. For example, signatures may simply be written to pick up specific patterns in a network traffic that might not be malicious at all but used for auditing purposes only. All of these signatures are loaded into the IDS before the IDS starts monitoring for suspicious activity on the network.

Below is an example of a signature rule written to detect security bugs in the imap protocol of the target server.

alert tcp $EXTERNAL_NET any -> $HOME_NET 143
(msg:“COMMUNITY IMAP GNU Mailutils request tag format string
vulnerability”; flow:to_server,established; content:“|25|”;
pcre:“/\hat{ }\S*\x25\S*\s/sm”;
reference:cve,CAN-2005-1523; reference:bugtraq,13764;
classtype:attempted-admin; sid: 100000135; rev:1;)

Computer networks were originally used to transfer application data within an organization, such as between researchers. However, companies quickly recognized the value in sharing information with trading partners such as suppliers, customers, and distributors, and others outside the organization. Furthermore, complex distributed applications within a corporation emerged. Business started requiring extensive application data exchange between many specialized applications such as CRM, ERP, Data warehouse, and custom applications. While such information sharing is frequently advantageous to the organization, such as when it facilitates collaboration between employees and customers, such transmissions can also be disadvantageous, such as when proprietary application data format is transmitted outside the organization, and especially when proprietary data is transmitted across to a peer which might not understand the application format. Thus, a means for defining a new portable data format was needed, and an application data format over TCP/IP began to emerge.

Today computers communicate using the TCP/IP protocol to exchange data. Millions of computers are connected via a heterogeneous network that is often referred to as the World Wide Web (WWW). The standard data format used by the World Wide Web to display data is Hypertext Markup Language (HTML) [www.w3c.org/MarkUp]. HTML is a language designed to display data and to focus on how data looks. HTML is the most widely deployed data standard for exchanging information over the World Wide Web. Over time as more and more businesses adopt the World Wide Web to conduct day to day operations, the limitations of HTML have become apparent.

While HTML is very good at graphically displaying information on a computer, it lacks the necessary richness to describe the information in detail and in various formats dynamically that is necessary for electronic commerce over the World Wide Web. The Extensible Markup Language (XML) [www.w3c.org/xml] standard provides the capability to richly describe the data and to focus more closely on the data, giving meaning to the data. XML gives meaningful structure to the data and allows for the user to dynamically add rules on how the data is to be interpreted by another party.

Only syntax and grammar is defined by the XML 1.0 standard [www.w3c.org/xml], which is currently endorsed by the W3C (World Wide Consortium) body. XML syntax is described by three important items: elements, attributes, and documents. These three items provide the building blocks for XML.

An element in XML is defined by a start tag and an end tag and data contained within it as shown by the following example: <Patent>XML</Patent> In this example, “Patent” is the element or tag containing the content “XML”. An attribute is a simple name-value pair where the value is in single or double quotes. An example of a name-value attribute is as follows: <Patent Type=“Network Security”>XML</Patent> This example describes an element “Patent” with name-value attribute where the name is “Type” and value is “Network Security”. The third element that forms the backbone of XML is the XML document itself. An XML document carries some properties that define the constraints by which it abides, making it well-formed. Some of the constraints of an XML document itself are as follows: There is exactly one root element; Every start tag has a matching end tag; No tag overlaps another tag. Below is an example of a well-formed XML document:

<?xml version=“1.0”encoding=“ISO-8859-1”?>
<note>
<to>Mamoon</to>
<from>Amandine</from>
<heading>Reminder</heading>
<body>Don't forget to call me this weekend!</body>
</note>

Further detail of the XML syntax constraints can be found in Extensible Markup Language (XML) 1.0 (Second Edition) W3C Recommendation 6 Oct. 2000, Tim Bray, Jean Paoli, C. M. Sperberg McQueen, Eve Maler.

Applications in the 1990s used Remote Procedure Calls (RPC) between objects like Distributed Component Object Model (DCOM) and Common Object Request Broker Architecture (CORBA), but Hypertext Transport Protocol (HTTP) was not designed for this. RPC represents a compatibility and security problem; firewalls and proxy services will normally block this kind of traffic. With the advent of XML and HTTP as the most common application transport protocol used over the World Wide Web (WWW), a new communication protocol emerged as the standard for Remote Procedure Calls between disparate applications running on different platforms. This protocol is known as the Simple Object Access Protocol (SOAP) [http://www.w3.org/TR/SOAP/] and uses HTTP as its transport and XML as its payload for sending and receiving messages. Since SOAP is based on XML, applications using SOAP as their interface can be programmed in different languages without any platform dependencies.

A SOAP message is an ordinary XML document containing elements such as a required Envelope element that identifies the XML document as a SOAP message. A SOAP message also includes an optional Header element that contains header information. A SOAP message includes a required Body element that contains call and response information. An optional Fault element provides information about errors. Below is an example of a sample SOAP message:

<?xml version“1.0”?>
<soap:Envelope xmlns:soap=http://www.w3.org/2001/12/soap-envelope

soap:encodingStyle=http://www.w3.org/2001/12/soap-encoding>

<soap:Header> .... </soap:Header>
<soap: Body> .... </soap: Body>
<soap: Fault> .... </soap: Fault>
</soap:Envelope>

When XML documents travel from one sender computer to a receiver computer it is essential that both computers have the same expectations about the content so the content sent by the sender will be understood by the receiver. With XML Schemas, the sender can describe the content in such a way that it can be validated by the receiver. Even if a document is well-formed it can still contain errors and those errors can cause problems for the receiver. Since XML Schema describes the structure of an XML document it provides an additional check for both the sender and the receiver to validate the document. XML schema language is also referred to as XML Schema Definition (XSD).

An XSD is written in XML itself. XSD defines the legal building blocks of an XML documents by defining: elements that can appear in a document, attributes that can appear in a document, which elements are child elements, the order of child elements, data types of elements, default and fixed values of elements. XSD is a W3C recommendation [http://www.w3.org/XML/Schema]. The following is an example of a sample XML document:

<?xml version=“1.0”?>
<note>
<to>Amandine</to>
<from>Mamoon</from>
<heading>Happybirthday</heading>
<body>May you have many more!!</body>
</note>

This follows with a simple XML Schema (XSD) that defines the elements of the XML document above.

<?xml version=“1.0”?>
<xs:schema xmlns:xs=“http://www.w3.org/2001/XMLSchema”

targetNamespace=“http://www.w3shools.com”
xmlns=“http://www.w3schools.com”
elementFormDefault=“qualified”>

<xs:element name=“note”>
<xs:complexType>
<xs:sequence>
<xs:element name=“to” type=“xs:string”/>
<xs:element name=“from” type=“xs:string”/>
<xs:element name=“heading” type=“xs:string”/>
<xs:element name=“body” type=“xs:string”/>
</xs:sequence>
</xs:complexType>
</xs:element>
</xs:schema>

Further description of an XSD can be found at http://www.w3.org/TR/xmlschema-0/.

Commercially available desktop applications such as Altova's XML SPY provide the ability to generate an XSD from a sample XML message. Such products are designed as desktop tools for authoring, creating and editing XML, XSD, XSLT, WSDL documents. A number of XML to XSD converter toolkits are also readily available.

The Web Services Description Language (WSDL) is a language standard that describes the interface with which to access a web service of an application. A WSDL may take the form of a file that is based on an XML format. WSDL describes network services as end-points that operate on, for example, SOAP or XML messages. The operations and messages associated with the web services are described along with data types of the SOAP messages through an XSD included in the WSDL file. The messages and operations may then be bound to concrete various protocols, such as Hypertext Transport Protocol (HTTP), Secure HTTP (HTTPS), Simple Mail Transport Protocol (SMTP), File Transport Protocol (FTP), Java Message Service (JMS). Today all of Web Services gateways, firewalls, proxies, or monitoring systems are provisioned with a WSDL. A deployment is WSDL-blind if the Web Services gateways, firewalls, proxies or monitoring systems are provisioned without the presence of a WSDL.

XML documents are treated as resources on the World Wide Web (WWW). These resources are identified by way of Uniform Resource Identifiers (URI) which is the Web's way of addressing resources. The most popular form of Uniform Resource Identifier is the Uniform Resource Locator (URL). Just as a URL is used to locate an XML document on the World Wide Web, the standard way to locate information within an XML document is a through a language known as the XML Path Language (XPath). XPath can be used to refer to textual data, elements, attributes, and other information in an XML document.

XPath is a sophisticated, complex language and uses path expression to identify information in an XML document. These path expressions look very much like the expression one sees when navigating a computer file system. An XPath pattern is a slash-separated list of child element names that describe a path through the XML document. The pattern “selects” elements that match the path. For example, in the sample XML document below, to locate the price of a shirt, the following XPath expression would be built: /catalog/shirts/price

<?xml version=“1.0” encoding=“ISO-8859-1”?>
<catalog>
<shirts>
<title>Dress Shirts</title>
<price>68.00</price>
</shirts>
</catalog>

Further details on XPath are available at further information [http://www.w3.org/TR/xpath].

### SUMMARY OF THE INVENTION

Traditional monitoring, security, and compliance Web Services are intrusive in nature and always rely on a Web Service Definition Language (WSDL) file to configure policies. In addition, the enforcement of these policies integrated from a security and compliance perspective further adds friction in managing policies.

The combination of intrusiveness, reliance on WSDL files, and integration of enforcement policies creates a scalability issue for network administrators who have to manage thousands of Web Services in a live deployment. By providing a non-intrusive technique that does not rely on a WSDL combined with external enforcement greatly eases the network administrator's job of managing Web Services.

Non-intrusive monitoring, security, and compliance of SOAP/XML messages may be combined with external enforcement of its policies in a WSDL-blind environment. There are certain scenarios where the method may be deployed in an non-intrusive manner with the presence of a WSDL, but these scenarios are exceptions and not the norm.

In one method for providing security and monitoring, signatures are generated dynamically, data packets in a network are passively scanned based on the signatures, and structured data within the data packets is processed. The signatures may be created by actively scanning a web service, or may be created from web service definition language (WSDL) files passively scanned in the network. Processing of the structured data may include providing statistics based on the structured data, and may include providing security for the structured data. Additionally, the data packets may be passively scanned for audit in an intrusion detection system (IDS) or an intrusion prevention system (IDS), or passively scanned for analytics. An exposure risk severity level may be generated based on the data packets and the exposure risk may be reported. Additionally, the network may be connected to the Internet.

Data packets may be passively scanned in a network and structured data in the data packets may be validated based on a schema. If the structured data fails validation, an external enforcement point is notified. Additionally, signatures may be dynamically generated based on the schema.

A system may passively scan data packets in a network that comprise interface definition of structured data, generate signatures based on the interface definition, and may passively scan the data packets based on the signatures. The interface definition may be in the form of a WSDL file. In addition, it may be determined whether the data packets violate rules that are based on the signatures, and at least one external enforcement point may be notified to block subsequent traffic if the data packets violate the rules.

The system may communicate structured data to an application service via a network, receive response structured data from the application service, and dynamically generate signatures based on the request and response structure data. In addition, the system may passively scan data packets in a network based on the signatures, and may determine whether the data packets violate a policy based on the signatures. If a data packet violates the policy, the system may notify at least one external enforcement point to block data packets that match signatures corresponding to the policy.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1a is a block diagram of OSI and TCP/IP stacks.

FIG. 1b is a block diagram that illustrates how network packets are processed against a signature rule.

FIG. 2a is a block diagram of an exemplary deployment mode of a SOAP/XML monitoring and security system within a network communications environment.

FIG. 2b is a block diagram of an exemplary deployment mode of a SOAP/XML non-intrusive based system connected to a layer 2-7 switch via SPAN port.

FIG. 2c is a block diagram of an exemplary deployment mode of a SOAP/XML non-intrusive based system in Tap Mode for SOAP/XML.

FIG. 2d is a block diagram of an exemplary deployment mode of a SOAP/XML system which is integrated into a layer 2-7 switch.

FIG. 3a is a flow chart of a sequence of steps that may be used to provide monitoring, security, or compliance with enforcement.

FIG. 3b is a flow chart of a sequence of steps that may be used to generate dynamic signatures from active scanning.

FIG. 3c is a flow chart of a sequence of steps that may be used to generate signatures derived from WSDL files scanned in a network.

FIG. 4a illustrates passive scanning of SOAP/XML messages for monitoring and enforcement.

FIG. 4b illustrates the flow of messages in a network based IDP/IPS deployment with active scanning.

FIG. 4c illustrates SOAP/XML message detection and enforcement in a network based IDP deployment.

### DETAILED DESCRIPTION OF THE INVENTION

A description of example embodiments of the invention follows.

A method scans SOAP and/or XML messages over TCP/IP and performs detection, monitoring, validation, and/or prevention from a monitoring, compliance, security, or integrity perspective. These goals are achieved through a combination of scanning SOAP and/or XML non-intrusively, without reliance on a WSDL and providing external enforcement. The combination of non-intrusiveness, WSDL-blindness, and external enforcement techniques truly provides a scalable and reliable deployment of Web Services at the enterprise level. The method may also be used in scenarios where the presence of WSDL or an XSD is required, but this an exception and not the norm.

Traditional techniques for monitoring, compliance, and security are intrusive because vendors rely on a proxy or an agent based solution. Companies such as IBM, Reactivity and SOA Software provide techniques to process SOAP/XML traffic and control that traffic by modifying the physical or logical path that leads to a Web Services application. The modification could come in terms of installing a proxy server between the client and a Web Service application where the proxy would trap messages and then provide statistics and security. This requires the client to be aware of the presence of a proxy server. The modification could also come in terms of installing an agent software that leads to installation of special software libraries that are linked to the monitored Web Services applications. This traditional technique adds friction in an enterprise deployment when thousands of Web Services need to be monitored and secured. These custom installments that modify the path cannot scale to such large deployments.

The non-intrusive technique of the method relies on a passive scanner. A passive scanner listens or monitors a network segment and captures any network packet that is destined for other hosts. The passive scanner does not touch the original network packet but only receives copies of network packets. For example, SOAP/XML messages may be scanned passively from the network without interrupting the path leading to a Web Services application. The key is that neither the client nor the Web Services application are aware of the presence of this technique. The technique leverages the current intrusion detection systems technology available in the industry and extends it to scan SOAP/XML traffic and to provide real time statistics, security, and enforcement with minimal configuration.

Traditional means of monitoring, compliance, and security of Web Services also rely on WSDLs for configuring policies. As developers constantly produce updated WSDLs, the WSDLs need to be pulled into the monitoring system. At the enterprise level, the problem can become acute as network administrators have to keep up with these ever changing WSDLs. A different approach taken by the method is to not rely on WSDLs at all, but leverage signatures as means of scanning SOAP/XML messages and providing exception processing on them, such as monitoring, security, compliance, and enforcement. The approach minimizes the management headache of tracking WSDLs that constantly get updated by developers of Web Services.

Traditional means of enforcement of Web Services policies could lead to blocking of certain types of SOAP/XML traffic. This enforcement technique is part of a Web Services gateway, firewall, or proxy implementation. The enforcement is not scalable since the enforcement is only at the point of where the monitoring, compliance and security is taking place. There is no external enforcement of policies to other gateways, firewalls, or proxies. This means that the enforcement of policies is not a scalable for Web Services and is only localized. The method, however, may enforce its policies on multiple external firewalls, switches, or routers without any hindrance based on a policy violation or a threshold being met during processing of SOAP/XML traffic.

The scanned SOAP/XML traffic may be matched against a set of signatures. If there is a match and the signatures “black-list” certain types of SOAP/XML traffic from traversing the network, then an alert is thrown with the option of blocking this type of traffic in the future by sending a block instruction to an external enforcement point such as a firewall. If the signatures “white-list” certain types of SOAP/XML traffic from traversing the network, that is, if the scanned SOAP/XML traffic does not match the signatures, then an alert is thrown with the option of sending a block instruction to an external enforcement point such as a firewall or router.

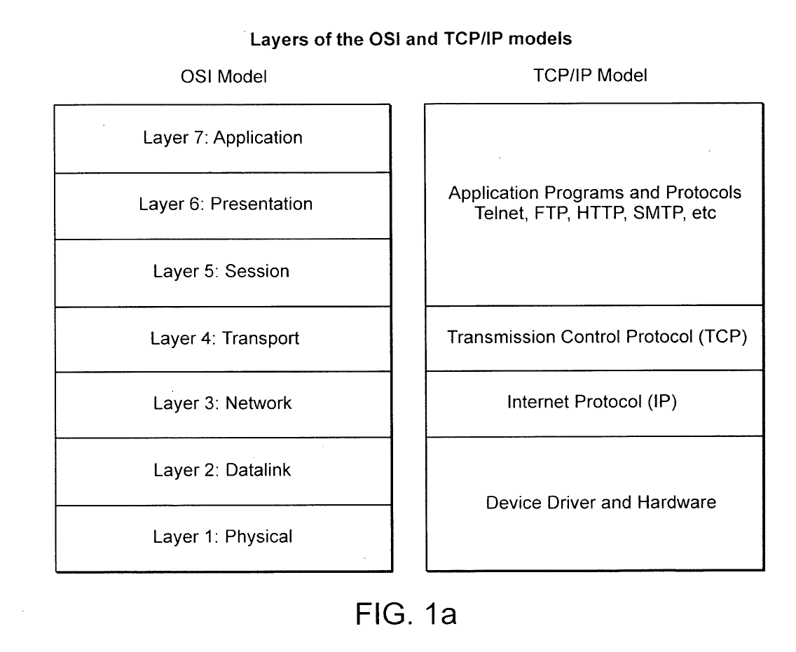

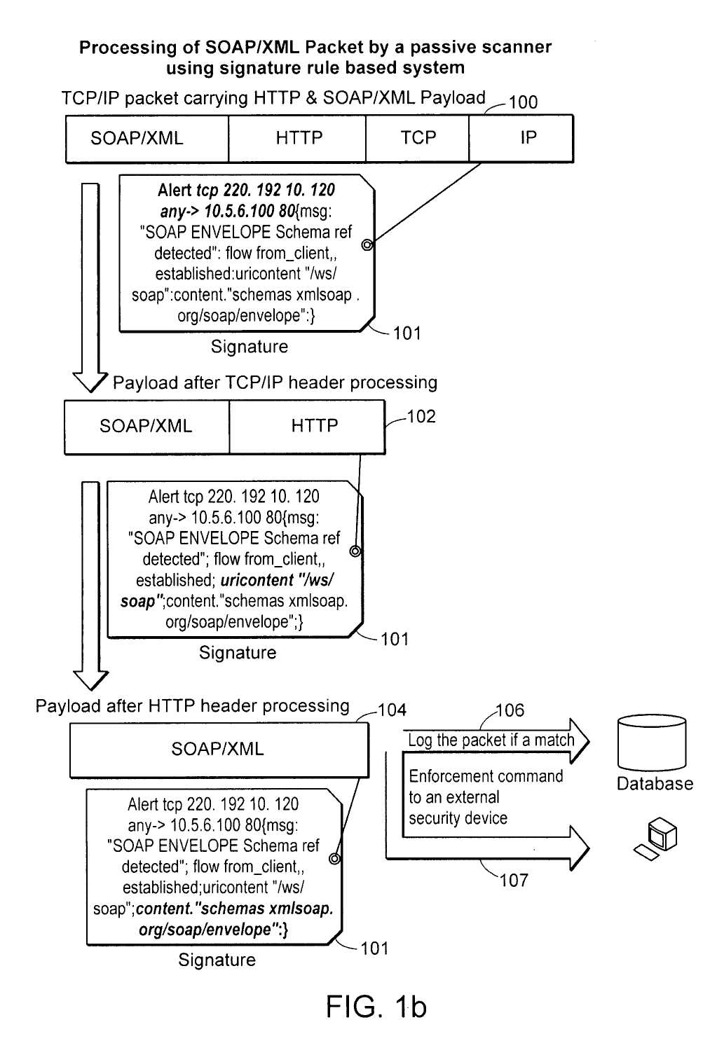

FIG. 1b illustrates the processing of a network packet that carries SOAP/XML message against a signature 101. The network packet 100 is matched with the network information in the signature 101. The information of the signature 101 being compared at each stage is italicized. Once the network information criteria is met, the packet passes to the next stage. Packet 102 is matched with the HTTP header information in the signature 101. Once the HTTP information criteria is met, the packet passes to the next stage. Next, only the SOAP/XML message is processed against the signature 101. If there is a match, then action 206 and/or action 207 is taken.

Another form or variation of controlling Web Services is to validate the structure of the SOAP/XML data flowing through the network. In the Web Services world, validating the structure of SOAP/XML messages against an XSD (XML Schema Definition) is performed by gateways, application servers, databases, or XML firewalls. All of these solutions are not only intrusive but increase the latency in processing transactions since these solutions are in the critical path. The method extends the notion of schema validation in an IDS environment by passively scanning SOAP/XML traffic and validating it against a pre-loaded XSD. If the validation fails, the method may then thrown an alert with the option of sending a block instruction to an external enforcement point such a firewall or router.

All techniques described by the method so far mainly rely on the combination of two fundamental concepts. Passive scanning of SOAP/XML traffic and matching it against set of signatures for monitoring, security, and compliance. Validating the structure of SOAP/XML messages is the only time when reliance on XSD is essential in addition to signatures. The method may rely on different techniques to generate signatures to monitor, secure, and control SOAP/XML traffic. The first technique involves creating signatures manually by hand. This is often the traditional method adopted by users to monitor and control network traffic. The second technique involves the dynamic generation of signatures based on active scanning. The third technique involves the scanning of WSDL files flowing over the network.

The second technique, active scanning, is a technique that provides an approach to testing applications for vulnerabilities or integrity errors by injecting bad messages to the application over the network and then examine responses. In the context of Web Services, bad SOAP/XML messages or mutant SOAP/XML messages are sent to a Web Service and responses are analyzed for security vulnerabilities or integrity errors. Co-pending U.S. Patent Application, “Technique for Determining Web Services Vulnerabilities and Compliance”, application Ser. No. 11/438,961, filed on May 23, 2006, covers the technique of active scanning of Web Services. The entire teachings of the application are incorporated herein by reference. The current method further builds upon the active scanning technique and dynamically generates signatures from bad SOAP/XML responses and feeds the signatures into the IDS.

Another approach to generating signatures involves the scanning of WSDL files flowing over the network. The method continuously monitors the network and if it sees the presence of a WSDL file in the network, it passively scans the file. Based on the scanned WSDL, the method then creates signatures. These signatures “white-list” the type of SOAP/XML traffic that is that is to be allowed on the network. Any SOAP/XML traffic that does not match the signatures generated from the scanned WSDL is marked as illegal.

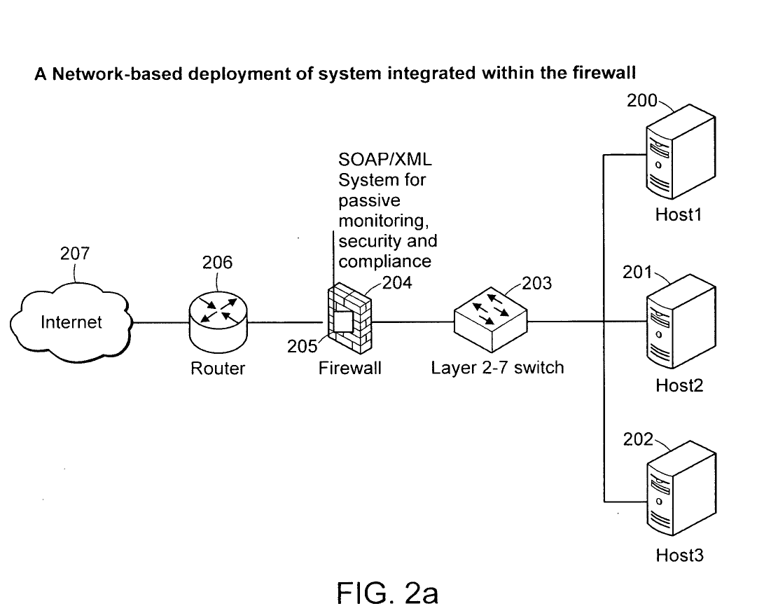

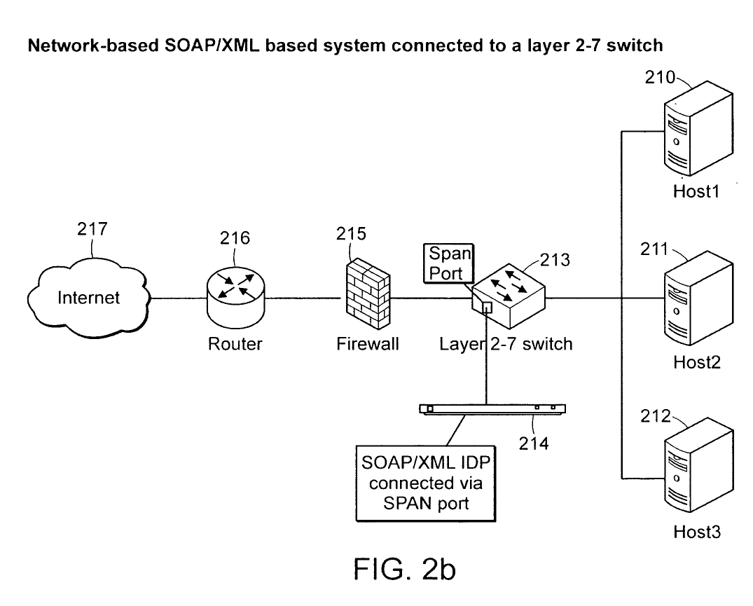

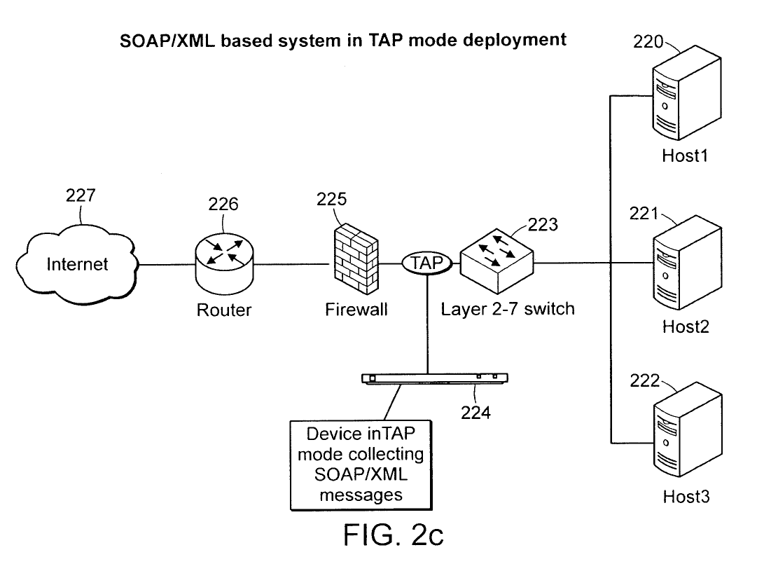

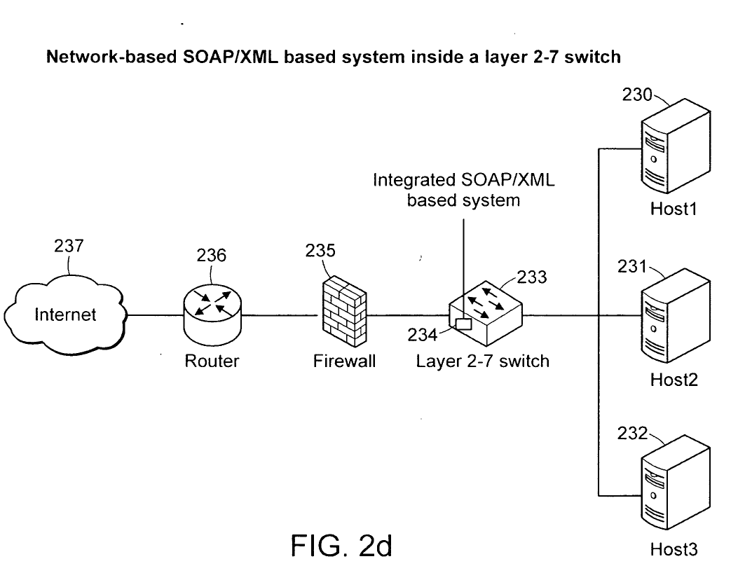

The method may be implemented in a network for passively scanning SOAP/XML messages as they traverse the network. SOAP/XML messages traversing a TCP/IP based network pass through the OSI layers and are processed in Layer 7. An alert is thrown if there is a signature match against the request or response SOAP/XML message. FIGS. 2a-2d illustrate a variety of deployment methods in a TCP/IP-based network.

FIG. 2a describes the implementation of the method as a system 205 in a typical network topology. This is the firewall configuration where the system 205 is installed as an integrated component of a firewall 204. In the current configuration, end hosts 200, 201, and 202 sit in a Local Area Network (LAN) which includes a Layer 2-7 switch 203, and the firewall 204. The firewall 204 provides outside access to the Internet 207, through a router 206. TCP/IP traffic carrying SOAP/XML from the Internet 207 that is destined for end host 200, 201, or 202 is first processed by the firewall 204. In this configuration the firewall 204 collects SOAP/XML packets and processes them through the rules engine that contains the signatures. It should be noted that the firewall 204 passes a copy of the SOAP/XML to the system 205 while it continues to send the messages to end host 200, 201, or 202. Thus the system is still in the critical path where it is not processing live packets. If there is a signature match in the rules engine then an alert is thrown to the user. TCP/IP traffic destination is the firewall 204 at a pre-configured TCP port which is then processed by the system 205 before being redirected to the end host 200, 201, or 202 for further processing.

FIG. 2b describes the implementation of the method in a typical network topology. This is the SPAN port configuration where the method is implemented in a dedicated appliance 214. In this configuration, end hosts 210, 211, and 212 sit in a Local Area Network (LAN) which includes a Layer 2-7 switch 213, and a firewall 215. The firewall 215 provides outside access to the Internet 217, through a router 216. The appliance 214 is connected to the SPAN port of the Layer 2-7 switch 213. This special SPAN port runs in promiscuous mode which enables it to pick up traffic that travels through all the physical ports of the Layer 2-7 switch 213. TCP/IP traffic carrying SOAP/XML from the Internet 217 that passes through the Layer 2-7 switch 213 will be picked up by the appliance 214. The appliance 214 is sitting in passive mode monitoring traffic since it does not interfere with the traffic flow, even if the appliance 214 is disabled. In this configuration the appliance collects SOAP/XML packets and processes them for monitoring, security, and compliance.

FIG. 2c describes the implementation of the method in a typical network topology. In the current configuration, end hosts 220, 221 and 222 sit in a Local Area Network (LAN) which includes a Layer 2-7 switch 223, and a firewall 225. The firewall 225 provides outside access to the Internet 227, through a router 226. This is the TAP port configuration where the method is implemented in a dedicated appliance 224 with a dedicated cable hooked into the physical wire that runs between the firewall 225 and the Layer 2-7 switch 223. The appliance 224 runs in promiscuous mode which enables it to pick up traffic that travels between the firewall 225 and Layer 2-7 switch 223. TCP/IP traffic carrying SOAP/XML from the internet 227 that passes through the Layer 2-7 switch 223 will be picked by the appliance 224. The appliance 224 sits in passive mode passively scanning traffic since it does not interfere with the traffic flow, even if the appliance 224 is disabled. In this configuration the appliance collects SOAP/XML packets data for monitoring, security, and compliance.

FIG. 2d describes the implementation of the method as a system in a typical network topology. This is the Layer 2-7 switch configuration where the system 234 is installed as an integrated component of a Layer 2-7 switch 233. In this configuration, end hosts 230, 231, and 232 sit in a Local Area Network (LAN) which includes the Layer 2-7 switch 233, and a firewall 235. The firewall 235 provides outside access to the Internet 237, through a router 236. TCP/IP traffic carrying SOAP/XML from the Internet 237 that is destined for end host 230, 231, or 232 is first processed by the Layer 2-7 switch 233. TCP/IP traffic destination is the Layer 2-7 switch's VIP (Virtual IP address) mapped to the backend host 230, 231, or 232. The TCP/IP packets that carry the SOAP/XML are processed in the switch 233 by the system 234 before being redirected to the end host 230, 231, or 233 for further processing. The processing by the system 234 is integrated in the Layer 2-7 switch 233. In this configuration the SOAP/XML packets pass through the Layer 2-7 switch 233 and if a SOAP/XML packet is detected, then it is handed off to the system 234 for deeper inspection. The system 234 will then perform a signature match on the packet for monitoring, security, and compliance.

It should be apparent to one skilled in the art that the software portions of the method may be implemented in a variety of programmatic languages including but not restricted to Java, C++, C#, Visual Basic, C, Python, Perl, Assembler and the like. The method may also be implemented in a variety of Operating Systems including but not restricted to Windows 2000/XP, Linux, Solaris, HP-UX, AIX, Mac-OS and the like. Each language and operating system has advantages and disadvantages in its use with the method, including performance, development time, portability, and the like. For example, a C-based and NET based implementation is described, it should be apparent to one skilled in the art that the method can be implemented in alternative languages.

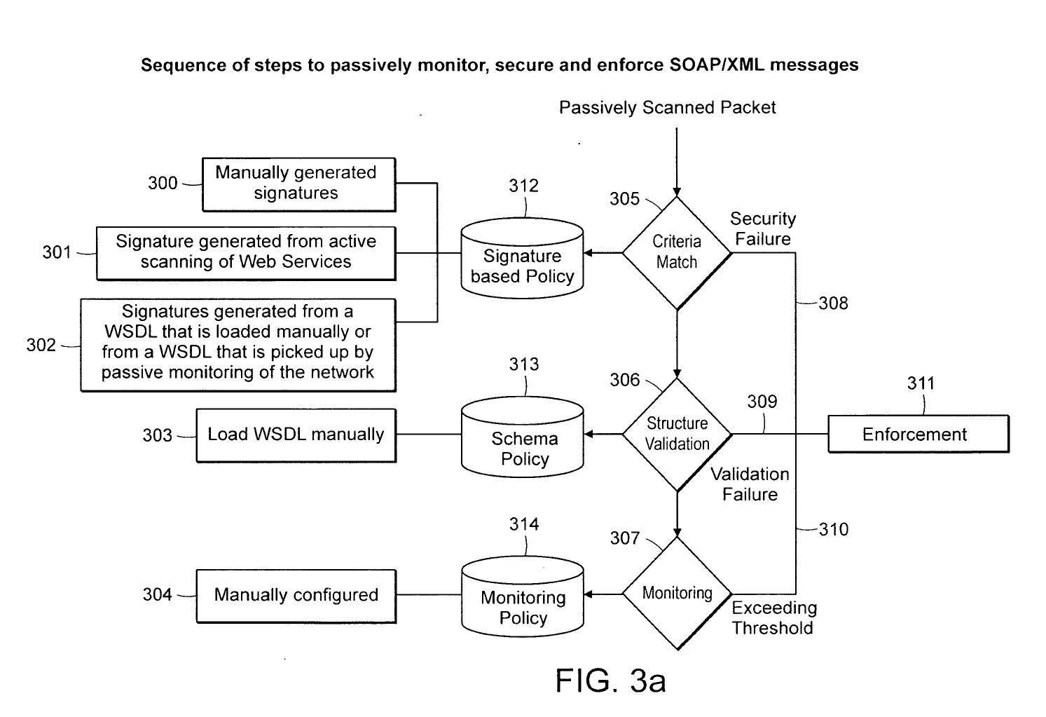

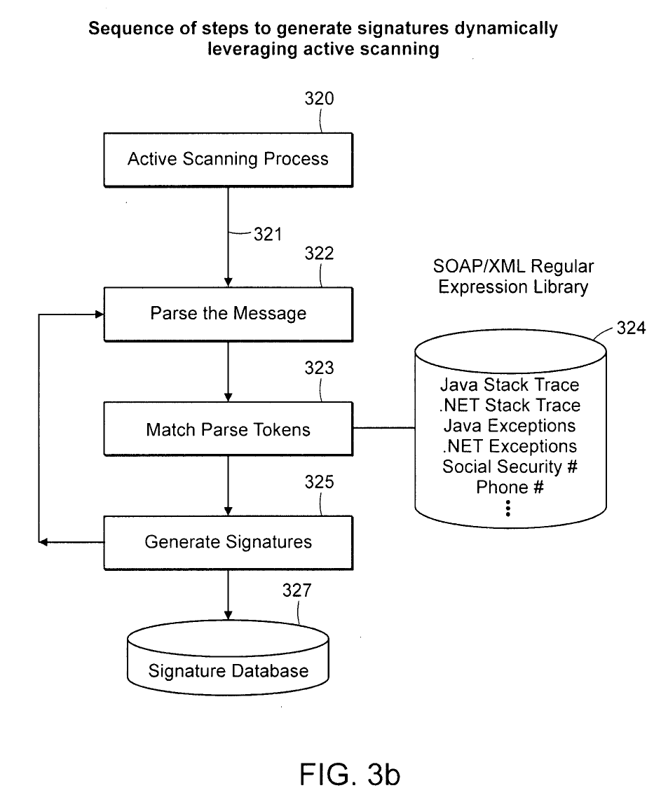

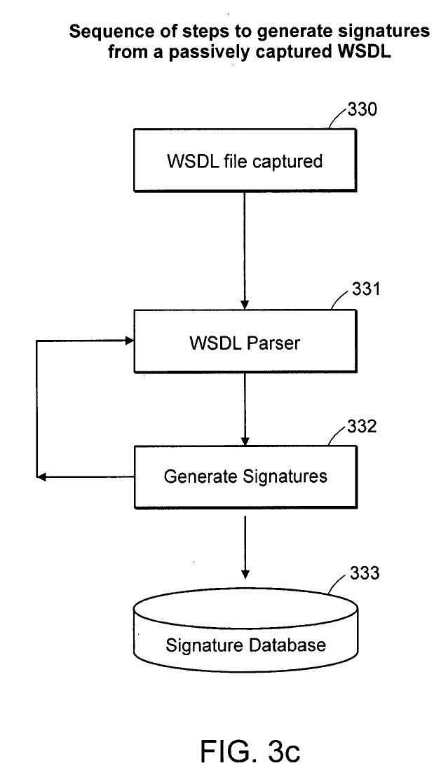

FIG. 3a is a flow chart of a sequence of steps that may be used to non-intrusively provide Web Services monitoring, security, and enforcement in a WSDL-aware and WSDL-blind environment. Steps 300, 301, 302, 303, and 304 show various ways that the method may be provisioned before the actual SOAP/XML are processed. It should be noted that steps 301 and 302 use a unique approach of generating signatures that define criteria with which SOAP/XML will be matched. Once the policies are provisioned via steps 300, 301, 302, 303, or 304, the SOAP/XML is scanned. Module 305 checks SOAP/XML against policies 312. If there is a security or compliance violation, the module 305 notifies 308 an external enforcement point 311. If there is no violation the SOAP/XML message is passed for further validation at module 306. Module 306 validates the structure of SOAP/XML messages against a XML Schema 313. If the validation fails, then module 306 notifies 309 the external enforcement point 311. If the validation passes, SOAP/XML passes to a monitoring module 307. Module 307 generates various statistics based on a monitoring policy 314. Module 307 also checks to determine whether certain thresholds are crossed. If module 307 decides that a certain threshold has been crossed, then module 307 notifies 310 the external enforcement point 311.

FIG. 3b is a flow chart of a sequence of steps that may be used to generate dynamic signatures. This dynamic signature generation process relies on an active scanning process to pass it bad SOAP/XML request and response messages before generating signatures. The flow starts with a testing tool or component 320 that performs active scanning of a web service resulting in bad SOAP/XML messages. The testing tool 320 performs step 321, loading the SOAP/XML message into a module 322 that parses the SOAP/XML message. The module 322 passes parsed tokens to module 323 that matches specific XML tokens against a pre-defined library 324 of generic regular expressions in 324. These matched tokens and regular expressions are passed to module 325 that generates custom signatures and updates the signature database 327. Module 325 will return control to module 322 via as long as SOAP/XML messages continue to be parsed.

FIG. 3c is a flow chart of a sequence of steps that may be used to generate signatures after scanning a WSDL passively from the network. The flow starts with passive scanning of a WSDL from the network in step 330. The scanned WSDL is parsed in step 331. Parsed elements of the WSDL are passed to module 332, which generates signatures. Module 332 passes generated signatures to a signature policy database 333. The module 332 then passes control back module 331 that will continue to parse the WSDL until it completes parsing the WSDL.

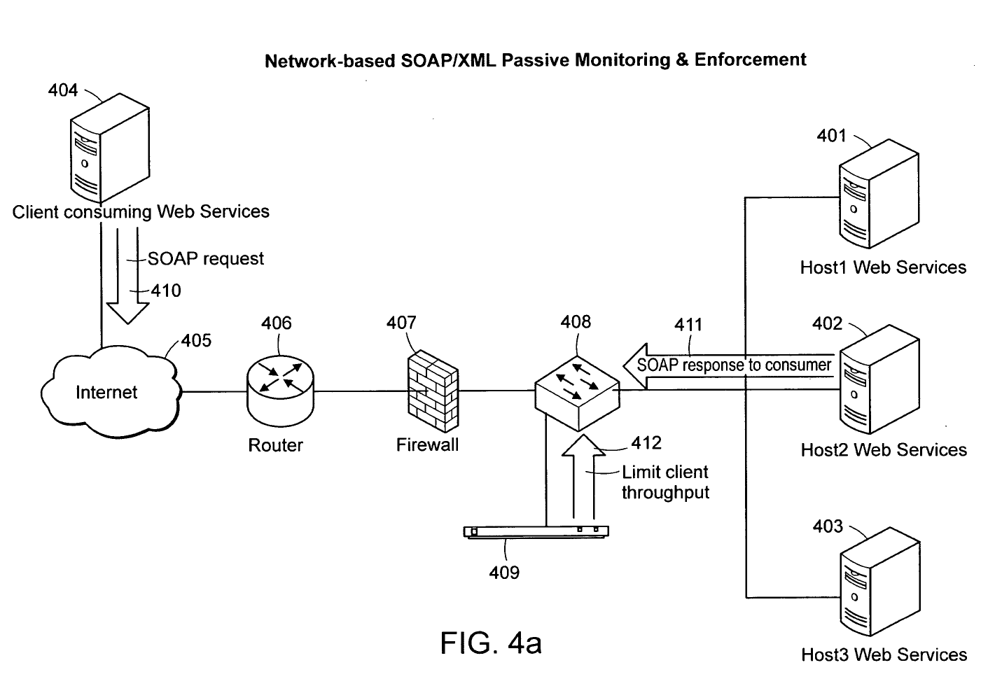

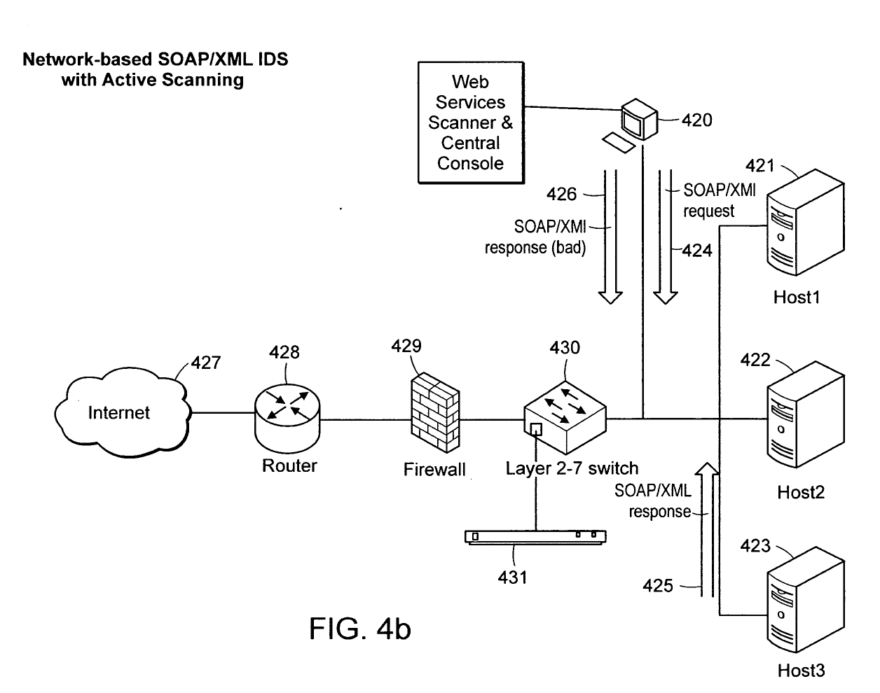

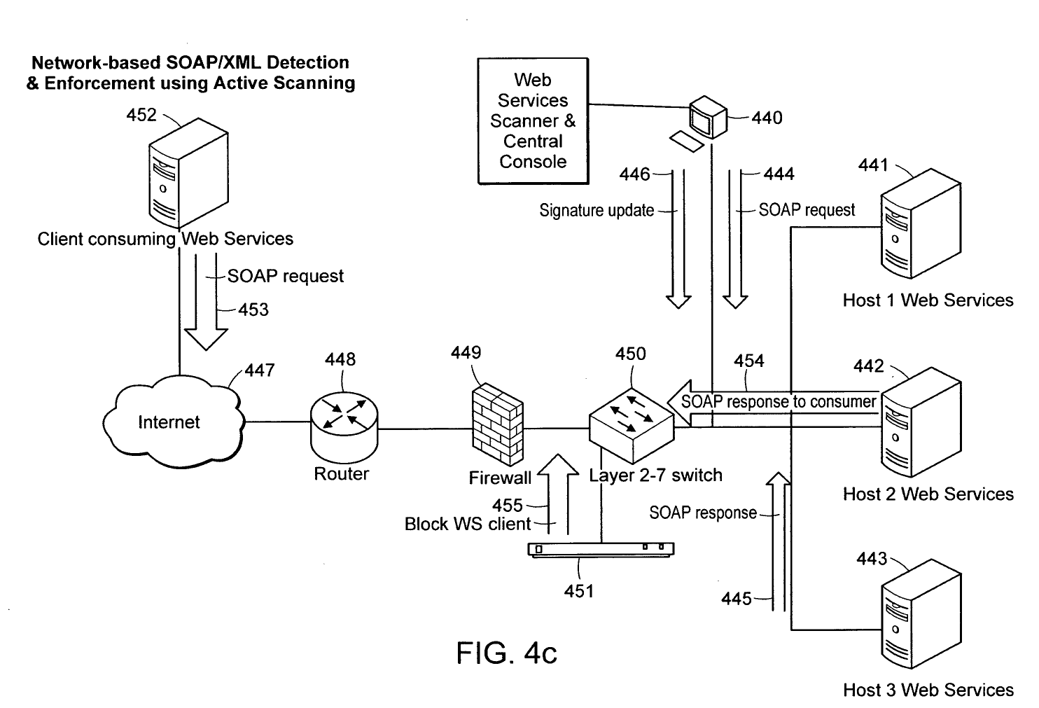

FIG. 4a illustrates an embodiment of the method which can non-intrusively monitor SOAP/XML traffic and notify an external enforcement point if certain thresholds are crossed. In this configuration, end hosts 401, 402, and 403 sit in a Local Area Network (LAN) which includes a Layer 2-7 switch 408, and a firewall 407. A firewall 407 provides outside access to the Internet 405, through a router 406. The appliance 409 is connected to the SPAN port of the Layer 2-7 switch 408. This special SPAN port runs in promiscuous mode which enables it to pick up traffic that travels through all the physical ports of the Layer 2-7 switch 408. TCP/IP traffic carrying SOAP/XML from the internet 405 that passes through the Layer 2-7 switch 408 will be picked up by the appliance 409. The appliance 409 is non-intrusive since it scans traffic passively and will not disrupt traffic flow, even if the appliance 409 is disabled. In this illustration, the Web Services client 404 sends a SOAP/XML request message 410 to Web Service application at end node 403. Web Service application at node 403 responds with SOAP/XML message 411. IDS appliance 409 scans both the request message 410 and the response message 411. Statistics are provided based on these messages, and if the statistics cross a pre-defined threshold, a command 412 will be sent to limit the traffic flow through the switch 408. In this example, a combination of monitoring and throttling is provided.

FIG. 4b illustrates an embodiment of the method that relies on active scanning to generate dynamic signatures which are then used for monitoring, security, and compliance. This deployment is a SPAN port configuration that uses a dedicated appliance 431. In the current configuration, an active scanner is installed on a console 420. In this configuration, end hosts 421, 422, and 423 sit in a Local Area Network (LAN) which includes a Layer 2-7 switch 430, and a firewall 429. The firewall 429 provides outside access to the Internet 427, through a router 428. The appliance 431 is connected to the SPAN port of the Layer 2-7 switch 430. This special SPAN port runs in promiscuous mode which enables it to pick up traffic that travels through all the physical ports of the Layer 2-7 switch 430. TCP/IP traffic carrying SOAP/XML from the internet 427 that passes through the Layer 2-7 switch 423 will be picked up by the appliance 431. The appliance 431 is sitting in passive mode passively scanning traffic since it does not interfere with the traffic flow, even if the appliance 431 is disabled. In this illustration, the active scanner 420 first sends a SOAP/XML message 424 to host 423. Host 423 responds back with a SOAP/XML message 425. If the message 425 is a bad response, then console 420 updates the appliance 431 with message 426 that is a copy of message 425. The appliance 431 will use message 426 to generate an IDS signature. This demonstrates the dynamic nature of signature generation. Any SOAP/XML messages that are scanned by IDS appliance 431 will be matched against these dynamically generated signatures for monitoring, security, or compliance.

FIG. 4c illustrates an embodiment of the method which can, through active scanning, create dynamic signatures for SOAP/XML Web Services and feed the signatures into a network based IDS appliance. The IDS appliance may enforce a policy to block SOAP/XML traffic that violates specific signature policies. This is the SPAN port configuration that uses a dedicated appliance 451. In the current configuration, an active scanner is installed on a console 440. In this configuration, end hosts 441, 442, and 443 sit in a Local Area Network (LAN) which includes a Layer 2-7 switch 450, and a firewall 449. The firewall 449 provides outside access to the Internet 447, through a router 448. A Web Services client 452 sits outside the firewall 449 and is allowed to consume Web Services from host 442. The appliance 451 is connected to the SPAN port of the Layer 2-7 switch 450. This special SPAN port runs in promiscuous mode which enables it to pick up traffic that travels through all the physical ports of the Layer 2-7 switch 450. TCP/IP traffic carrying SOAP/XML from the internet 447 that passes through the Layer 2-7 switch 450 will be picked up by the appliance 451. The appliance 451 is non-intrusive since it does not interfere with the traffic flow, even if the appliance 451 is disabled. In this configuration the appliance collects SOAP/XML packets and processes them through a rules engine that contains the signatures. If there is a signature match in the rules engine then an alert is thrown to the user.

Active scanner 440 initiates scanning of Web Services running on 443 by sending a SOAP/XML payload 444. Payload 444 is destined for Web Services on host 443. Web Services on host 443 responds with a SOAP/XML message 445 which contains bad data. Active scanner 440 detects this bad data in the response message 445 and sends a copy of message 445 as message 446 to the IDS appliance 451. The appliance generates a signature from the message 446. In this configuration, client 452 then sends a SOAP/XML request 453 to host 442. Host 442 Web Services responds with a bad SOAP response 454 which is scanned by the IDS appliance 451. If the bad SOAP response 454 matches the signature, it triggers an alert set by the appliance 451. The appliance, as result of the trigger, sends a block command 455 to firewall 449. The firewall 449 will update its firewall rules and block any new Web Services traffic originating from client 452.

While this invention has been particularly shown and described with references to example embodiments thereof, it will be understood by those skilled in the art that various changes in form and details may be made therein without departing from the scope of the invention encompassed by the appended claims.

What is claimed is:

1. A method for providing security and monitoring, comprising the steps of:
dynamically generating signatures;
passively scanning data packets in a network based on the signatures; and
processing structured data within the data packets.

2. The method of claim 1, wherein the signatures are created by actively scanning a web service.

3. The method of claim 1, wherein the signatures are created from web service definition language (WSDL) files in the network, the files being passively scanned.

4. The method of claim 1, wherein processing the structured data includes providing statistics based on the structured data.

5. The method of claim 1, wherein processing the structured data includes providing security for the structured data.

6. The method of claim 1, further comprising the step of:
passively scanning the data packets for audit in an intrusion detection system (IDS) or an intrusion prevention system (IPS).

7. The method of claim 1, further comprising the step of:
passively scanning the data packets for analytics.

8. The method of claim 1, further comprising the step of:
generating an exposure risk severity level based on the data packets.

9. The method of claim 8, further comprising the step of:
reporting the exposure risk severity level.

10. The method of claim 1 wherein the network is connected to the Internet.

11. A method for providing security and monitoring, comprising the steps of:
passively scanning data packets in a network;
validating structured data in the data packets based on a schema; and
notifying an external enforcement point if the structured data fails validation.

12. The method of claim 11, further comprising the step of:
dynamically generating signatures; and
wherein passively scanning the data packets includes passively scanning the data packets based on the signatures.

13. The method of claim 12, wherein the signatures are generated based on the schema.

14. The method of claim 12, further comprising the step of:
providing statistics based on the structured data.

15. The method of claim 12, further comprising the step of:
providing security for the structured data.

16. A method for providing security and monitoring, comprising the steps of:
passively scanning data packets in a network, the data packets comprising interface definition of structured data; and
generating signatures based on the interface definition.

17. The method of claim 16, wherein the interface definition is a web service definition language (WSDL) file.

18. The method of claim 16, further comprising the step of:
passively scanning the data packets based on the signatures.

19. The method of claim 18, further comprising the steps of:
determining whether the data packets violate rules, the rules based on the signatures; and
notifying at least one external enforcement point to block subsequent traffic if the data packets violate the rules.

20. A method for providing security and monitoring, comprising the steps of:
communicating structured data to an application service via a network;
receiving response structured data from the application service; and
dynamically generating signatures based on the request and response structure data.

21. The method of claim 20, further comprising the step of:
passively scanning data packets in the network based on the signatures.

22. The method of claim 21, further comprising the step of:
determining whether the data packets violate a policy, the policy being based on the signatures.

23. The method of claim 22, further comprising the step of:
if a data packet violates the policy, notifying at least one external enforcement point to block data packets that match signatures corresponding to the policy.

24. A method for providing security and monitoring, comprising the steps of:
dynamically generating signatures;
passively scanning data packets in a network based on the signatures;
providing statistics on structured data within the data packets;
validating structured data in the data packets based on a schema; and
notifying an external enforcement point if the structured data fails validation.
